(19) United States
(12) Patent Application Publication
(10) Pub. No.: US 2011/0214115 A1
(43) Pub. Date: Sep. 1, 2011

(54) METHOD AND APPARTUS FOR PROVIDING A HIGH LEVEL MOBILE VIRTUAL MACHINE

(75) Inventors: Kimmo Kalervo Kuusilinna, Berkeley, CA (US); Richard Edward Honicky, JR., Albany, CA (US); Eric Brewer, Mill Valley, CA (US)

(73) Assignee: Nokia Corporation

(21) Appl. No.: 12/713,748

(22) Filed: Feb. 26, 2010

(51) Int. Cl. G06F 9/455; G06F 9/44

(52) U.S. Cl. 717/171; 718/1

(57) ABSTRACT

An apparatus for providing a high level mobile virtual machine may include at least one processor and at least one memory including computer program code. The at least one memory and the computer program code may be configured to, with the at least one processor, cause the apparatus to perform at least maintaining a record, at a service platform, of service software versions employed at one or more virtual machines, providing a service software upgrade from the service platform to at least one of the one or more virtual machines, and tracking which of the one or more virtual machines employs the service software upgrade. A corresponding method and computer program product are also provided.

### TECHNOLOGICAL FIELD

Embodiments of the present invention relate generally to electronic device technology and, more particularly, relate to a method and apparatus for providing a high level mobile virtual machine.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

Various applications and software have also been developed and continue to be developed in order to give the users robust capabilities to perform tasks, communicate, obtain information or services, entertain themselves, etc. in either fixed or mobile environments. Given the robust capabilities of mobile electronic devices and the relatively small size of such devices, it is becoming increasingly common for individuals to keep mobile electronic devices on or near their person on a nearly continuous basis. Moreover, because such devices are being mass produced and network coverage has reached over much of the world, the devices are becoming ubiquitous even in developing nations. However, in some areas, network capabilities and the devices they serve are more limited than in others. Thus, it may be a challenge to provide high quality services to users in certain environments.

Accordingly, it may be desirable to provide a mechanism by which at least some of the issues discussed above may be addressed.

### BRIEF SUMMARY

A method, apparatus and computer program product are therefore provided for enabling the provision of a high level mobile virtual machine. Accordingly, for example, a virtual machine may be provided on a mobile device that may have capabilities beyond merely emulation of a computer or processor. Instead, a virtual machine according to some example embodiments may be configured to emulate web services. Furthermore, some embodiments of the present invention may provide an updateable virtual machine through management of versioning.

In one example embodiment, a method of providing a high level mobile virtual machine is provided. The method may include maintaining a record, at a service platform, of service software versions employed at one or more virtual machines, providing a service software upgrade from the service platform to at least one of the one or more virtual machines, and tracking which of the one or more virtual machines employs the service software upgrade.

In another example embodiment, a computer program product for providing a high level mobile virtual machine is provided. The computer program product includes at least one computer-readable storage medium having computer-executable program code instructions stored therein. The computer-executable program code instructions may include program code instructions for maintaining a record, at a service platform, of service software versions employed at one or more virtual machines, providing a service software upgrade from the service platform to at least one of the one or more virtual machines, and tracking which of the one or more virtual machines employs the service software upgrade.

In another example embodiment, an apparatus for providing a high level mobile virtual machine is provided. The apparatus may include at least one processor and at least one memory including computer program code. The at least one memory and the computer program code may be configured to, with the at least one processor, cause the apparatus to perform at least maintaining a record, at a service platform, of service software versions employed at one or more virtual machines, providing a service software upgrade from the service platform to at least one of the one or more virtual machines, and tracking which of the one or more virtual machines employs the service software upgrade.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a system according to an exemplary embodiment of the present invention;

FIG. 3 is a schematic block diagram of an apparatus for providing a high level mobile virtual machine according to an exemplary embodiment of the present invention;

FIG. 4 is a schematic block diagram of another apparatus for providing a high level mobile virtual machine according to an exemplary embodiment of the present invention;

FIG. 5 illustrates an example of potential systems that may be constructed by specifying backend processing and storage logic at one device and virtual machine logic at a client device and by specifying the protocol for communication between the backend processing and storage logic and the virtual machine logic according to an exemplary embodiment of the present invention;

FIG. 6 illustrates an example in which operation of an example embodiment is shown for each of three different scenarios including a client with current software, a client that includes old software that has not yet been upgraded and a client that is incompatible based on its current software;

FIG. 7 is a block diagram according to an example method for providing a high level mobile virtual machine according to an example embodiment of the present invention; and

FIG. 8 is a block diagram according to another example method for providing a high level mobile virtual machine according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

Web services may provide many advantages to users and providers, including amortized maintenance costs, increased data safety, reduced hardware requirements (for the user), easy collaboration between users, and easily upgradeable software. Web services have also increasingly moved towards rich user interfaces that are comparable to desktop-applications using javascript based presentation combined with asynchronous communication with a server. These types of applications are particularly appealing for mobile device users for several reasons, including the ability to safely store data in a network cloud, the ability to access data from multiple devices and platforms, the ability to conduct management transparently by a service provider, and the ability to foster collaboration of mobile devices.

Some web services, such as social networking sites (e.g., Facebook, MySpace, LinkedIn, Orkut, Friendster, etc.) have enabled people to utilize their existing contacts for establishing new social and business links. These types of websites offer many services such as locating friends and contacts, finding jobs and businesses, sharing profile and content (e.g., music, photos, videos, text data, etc.), providing birthday reminders, listing classifieds, and many others. These services can assist in improving one's professional and personal relations and can serve as marketing tools for professionals.

While many high end mobile devices and their corresponding high end networks support powerful web browsers and fast data networks with expressive and richly interactive user interfaces (e.g., touch screens), these devices and networks can be relatively expensive and somewhat limited in availability. Thus, for example, users in the developing world, or users with limited budgets, may find the high end devices and network offerings to be out of reach. Instead, such users may find relatively simple mobile devices with relatively modest data or access plans to be the only practical or realistic options that are available or desirable. Embodiments of the present invention may provide a mechanism by which to provide web-like services and their accompanying advantages to users that are either cost sensitive or otherwise have access only to simple devices or somewhat low bandwidth or high latency networks.

Some embodiments of the present invention may provide for a high level virtual machine that can be employed on mobile devices. The high level mobile virtual machine may be provided on a mobile terminal to extend capabilities of the virtual machine beyond merely emulation of a computer or processor to emulation of web services. Furthermore, some embodiments of the present invention may provide that the high level virtual machine is updateable or upgradeable via software and data management.

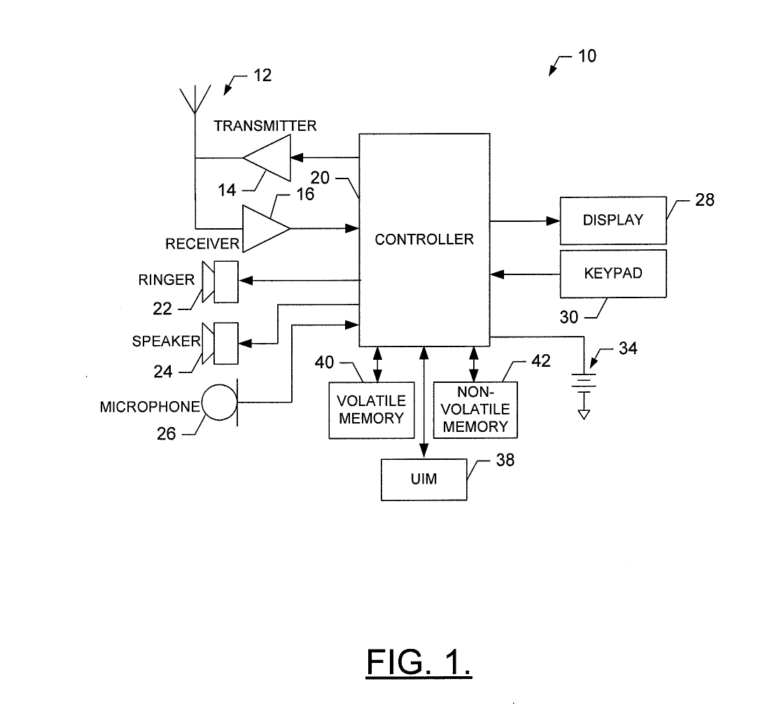

FIG. 1, one example of a device that may benefit from implementation of an exemplary embodiment of the invention, illustrates a block diagram of a mobile terminal 10. It should be understood, however, that a mobile terminal as illustrated and hereinafter described is merely illustrative of one type of device that may benefit from embodiments of the present invention and, therefore, should not be taken to limit the scope of embodiments of the present invention. Several different embodiments of the mobile terminal 10, such as portable digital assistants (PDAs), pagers, mobile telephones, mobile televisions, gaming devices, all types of computers (e.g., laptops or mobile computers), cameras, audio/video players, radio, global positioning system (GPS) devices, or any combination of the aforementioned, and other types of communications devices, may readily employ embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processor, which provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocols such as E-UTRAN (evolved-universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

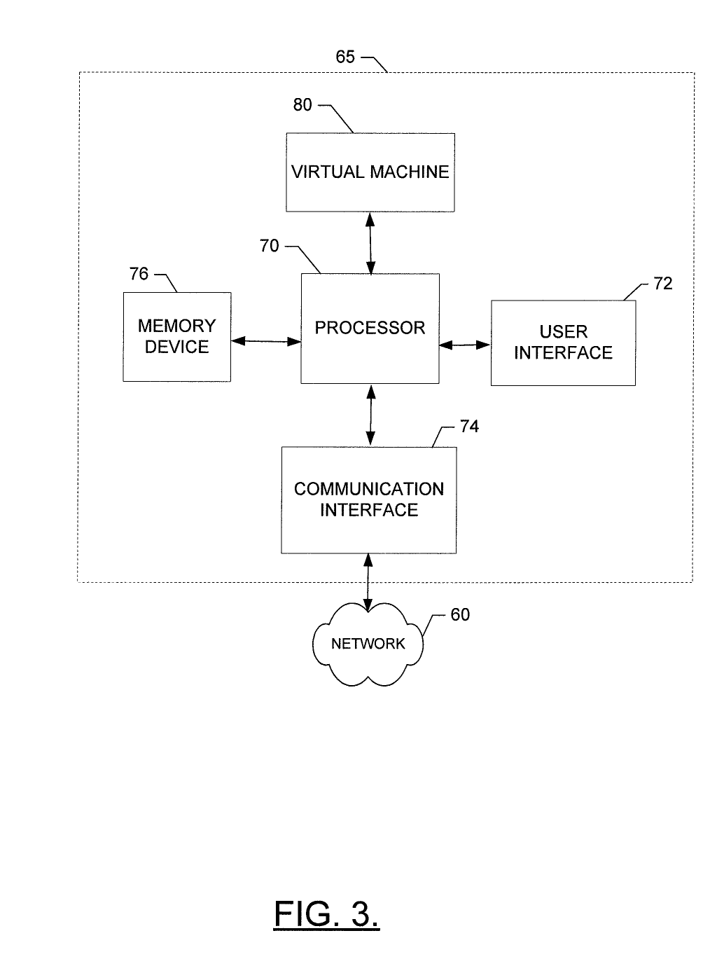

It is understood that the controller 20 may include circuitry implementing, among others, audio and logic functions of the mobile terminal 10. For example, the controller 20 may comprise a digital signal processor device, a microprocessor device (e.g., processor 70 of FIG. 3), and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown), a microphone or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random

Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

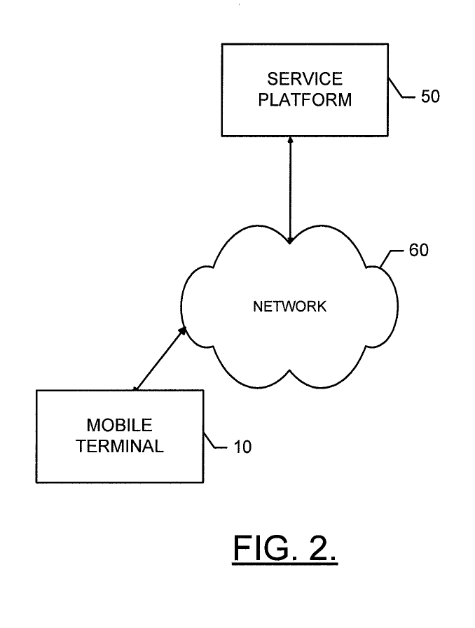

FIG. 2 illustrates a generic system diagram in which a device such as the mobile terminal 10, which may benefit from embodiments of the present invention, is shown in an exemplary communication environment. In this regard, the mobile terminal 10 may be configured to include an apparatus for employing a high level virtual machine in accordance with an exemplary embodiment. As shown in FIG. 2, an embodiment of a system in accordance with an example embodiment of the present invention may include a first communication device (e.g., mobile terminal 10) and a service platform 50 capable of communication with each other via a network 60. In some cases, embodiments of the present invention may further include one or more network devices or other mobile or fixed communication devices with which the mobile terminal 10 and/or the service platform 50 may communicate to provide, request and/or receive information. The network devices may include, for example, one or more servers, base stations, access points, gateways, communication controllers or other computers configured to perform various functions. In some cases, embodiments of the present invention may also or alternatively be practiced on one or more of the network devices and/or the communication devices that communicate with each other and/or the network devices.

In an example embodiment, the service platform 50 may be a device or node such as a server or other processing circuitry. The service platform 50 may have any number of functions or associations with various services. As such, for example, the service platform 50 may be a platform such as a dedicated server, backend server, or server bank associated with a particular information source, function or service. As such, the service platform 50 may represent one or more of a plurality of different services or information sources. The functionality of the service platform 50 may be provided by hardware and/or software components configured to operate in accordance with known techniques for the provision of information to users of communication devices, except as modified as described herein.

In an exemplary embodiment, the service platform 50 may provide, among other things, data and software management (e.g., versioning management), storage, processing, and other services related to communication with the mobile terminal 10 and other devices. In some cases, the service platform 50 may have multiple functionalities and provide multiple services. Thus, for example, the service platform 50 may also provide content sharing services, social network services, online market or store services for physical articles, digital content or applications, communication services and numerous others.

The network 60, may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network 60. One or more communication terminals such as the mobile terminal 10 and the service platform 50 may be in communication with each other via the network 60 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices (e.g., personal computers, server computers or the like) may be coupled to the mobile terminal 10 and/or the service platform 50 via the network 60. By directly or indirectly connecting the mobile terminal 10 and/or the service platform 50 and other devices to the network 60 or to each other, the mobile terminal 10 and/or the service platform 50 may be enabled to communicate with the other devices or each other, for example, according to numerous communication protocols including Hypertext Transfer Protocol (HTTP) and/or the like, to thereby carry out various communication or other functions of the mobile terminal 10 and/or the service platform 50, respectively.

Furthermore, although not specifically shown in FIG. 2, the mobile terminal 10 may communicate with other devices in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the service platform 50 may be enabled to communicate with the network 60 and each other by any of numerous different access mechanisms. For example, mobile access mechanisms such as wideband code division multiple access (W-CDMA), CDMA2000, global system for mobile communications (GSM), long term evolution (LTE), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

An exemplary embodiment of the invention will now be described with reference to FIG. 3, in which certain elements of an apparatus for enabling the provision of a high level virtual machine are displayed. The apparatus of FIG. 3 may be employed, for example, on the mobile terminal 10 of FIG. 1. However, it should be noted that the apparatus of FIG. 3, may also be employed on a variety of other devices, both mobile and fixed (e.g., computers or servers), and therefore, embodiments of the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 3, an apparatus 65 for enabling the provision of a high level virtual machine is provided. The apparatus 65 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the mobile terminal 10 or a network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a virtual machine (VM) 80. The VM 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the VM 80 as described below. Thus, in examples in which software is employed, a device or circuitry (e.g., the processor 70 in one example) executing the software forms the structure associated with such means. In an example embodiment, the VM 80 may be configured to provide, among other things, for the execution of low level instructions (e.g., add, load, store, and other like functions) that a typical VM emulating a computer or processor is capable of executing. In an example embodiment, the VM 80 may also be configured to provide for execution of high level instructions. For example, the VM 80 may be configured to include opcodes (operation codes) for executing high level library calls (e.g., instructions to send a short message service (SMS) message, marshalling or unmarshalling of messages, initiation of phone calls, loading frames onto a display screen from a template, storing a record of data persistently and other higher level functions).

In an exemplary embodiment, the VM 80 may run on a framework of the mobile terminal 10 (or any other device on which the VM 80 is deployable). The framework of the device on which the VM 80 runs may include the operating system of the mobile terminal 10 or the processor 70 of the mobile terminal 10. Furthermore, the VM 80 may be embodied as any device or means embodied in either hardware, computer program product, or a combination of hardware and software that is capable of executing applications and/or instructions like a computer otherwise would, but in a manner that isolates the VM 80 from the operating system of the device on which the VM 80 is employed. In an exemplary embodiment, however, the VM 80 may be embodied in software as instructions that are stored on a memory of the mobile terminal 10 and executable by a processor (e.g., processor 70).

In an exemplary embodiment, the VM 80 may employ opcodes that may be, for example, eight bits (one byte) long. Accordingly, the VM 80 may essentially have two hundred and fifty six primary opcodes with which to work. A typical system might also define one or more opcodes as specifying a secondary opcode in a second byte or possibly third byte of an operation to unlock the potential to define significantly more opcodes than two hundred and fifty six. A typical instruction set may use a complex instruction set computer (CISC) architecture, allowing for variable length operations. Accordingly, a straightforward mapping from opcodes to underlying library function calls may be provided. Some embodiments may have typical operations such as load, store, jump, branch variants, comparisons, and arithmetic and binary operations. The architecture of the VM 80 may also have several general purpose registers, a stack pointer, a program counter, an interrupt flag, and other typical registers of a modern virtual machine. The VM 80 may also include a typical memory model.

The VM 80 may also include a mechanism for installing new or modified opcodes. As such, the VM 80 may be dynamically updateable or upgradeable on the fly. Thus, new or modified opcodes and/or semantic changes may be introduced and old opcodes may be deprecated or modified over the air. In an example embodiment, upgrading may be managed at the service platform 50, using specially defined messages for adding or modifying opcodes. The messages may then be provided to the VM 80 (e.g., via SMS or other ways). During implementation, a function may first be defined (responsive to message receipt) using existing operations of the VM 80. The operations may be pre-complied down to un-virtualized instructions on the mobile terminal 10 (or other client device). An opcode may then be registered on the mobile terminal 10 to call the new function. The operation layout may be defined using an operation description, and mapped to the function call. In some embodiments, a compiler at the service platform 50 may be configured to map function calls to opcodes where appropriate for the VM 80. The compiler may be for an existing language such as python or Java, for a subset of an existing language or for a new language. Some implementations may support extensions to support remote messaging. Moreover, in some cases, the VM 80 itself may include a separate compiler for creating a new opcode by compiling existing opcodes and/or other direct machine code and mapping it to a new opcode.

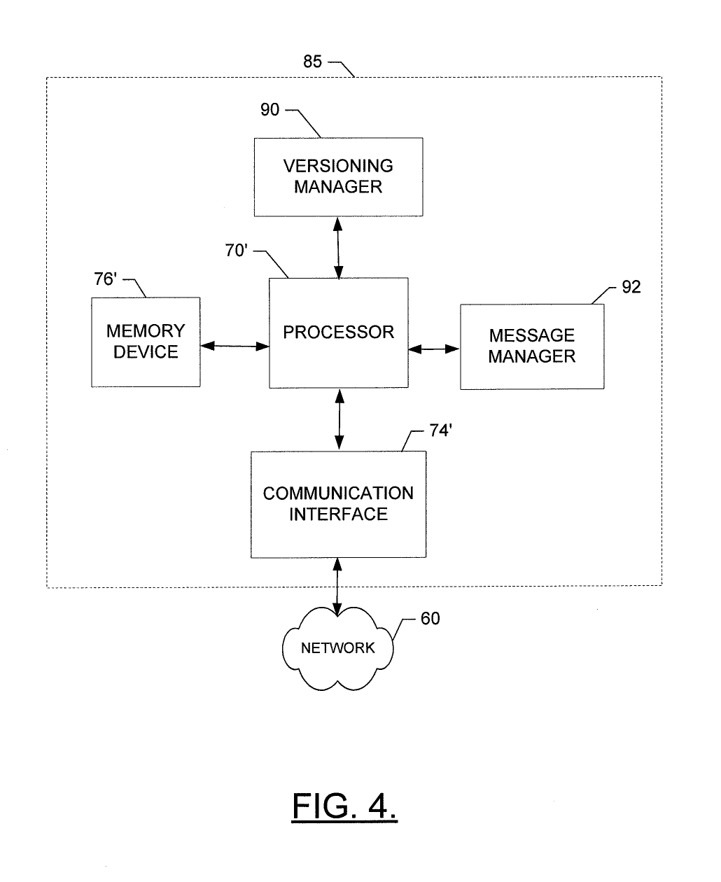

At the service platform 50, another apparatus 85 may be provided for managing versioning of the VM 80 and for providing messages to direct changes to operation of the VM 80. FIG. 4 illustrates a block diagram of the apparatus 85 according to an example embodiment. The apparatus 85 may include or otherwise be in communication with a processor 70′, a communication interface 74′ and a memory device 76′. Although some embodiments may not include any user interface and no such user interface is shown in FIG. 4, the apparatus 85 could also include a user interface. Functional capabilities and basic structure of the processor 70′, the communication interface 74′ and the memory device 76′ may be similar to the corresponding capabilities and basic structure described above in relation to the processor 70, the communication interface 74 and the memory device 76 described above in connection with the description of FIG. 3. Accordingly, specific details of the structure of the processor 70′, the communication interface 74′ and the memory device 76′ will not be repeated. However, it should be noted that exact details such as memory size and construction or processor speed and/or the like may be different (and perhaps larger/faster) for the apparatus 85 of FIG. 4 than for the corresponding devices of the apparatus 65 of FIG. 3.

In an example embodiment, the processor 70′ may be embodied as, include or otherwise control a versioning manager 90 and a message manager 92. The versioning manager 90 and the message manager 92 may each be any means such as a device or circuitry operating in accordance with software or otherwise embodied in hardware or a combination of hardware and software (e.g., processor 70′ operating under software control, the processor 70′ embodied as an ASIC or FPGA specifically configured to perform the operations described herein, or a combination thereof) thereby configuring the device or circuitry to perform the corresponding functions of the versioning manager 90 and the message manager 92, respectively, as described herein. Thus, in examples in which software is employed, a device or circuitry (e.g., the processor 70′ in one example) executing the software forms the structure associated with such means.

The versioning manager 90 may be configured to execute version tracking to enable, for example, web-like ability to easily upgrade service software such as network protocols and data storage, while ensuring that all clients and servers can communicate without interruption due to incompatibility. Moreover, since different clients may be in different states of upgrade at any time depending upon their communication state or capabilities at any given time, the versioning manager 90 may be enabled to track upgrade states for a plurality of client devices over time. In other words, since some upgraded clients have new code, while other non-upgraded clients may be implementing old code, the versioning manager 90 may be configured to track which version each client is using and respond to each respective client using the appropriate communication protocols, application semantics and storage protocols until clients have been upgraded.

In some cases, a service or set of services may be structured as a set of inter-dependent modules having a dependency graph that can be tracked explicitly by the versioning manager 90. When a semantic change is made to a particular module, the inter-dependent modules that may be affected by the semantic change may be marked or otherwise indicated as being affected. In other words, for example, the dependencies between changes in each module may be tracked by analysing an inter-module function-call graph of the various modules. When an upgrade to the corresponding client takes place, only modules that have been marked or otherwise indicated as needing a change may be concurrently changed. For example, a typical implementation may upgrade modules for each client by sending them the new code and the dependencies for each module. As all of a module's dependencies are satisfied, the client can switch to the new version of that module, and the corresponding code on the server. Thus, partial client upgrades may be conducted.

Other more sophisticated mechanisms relying on a version-control repository to track specific dependencies between modules for a specific set of change-sets may also be implemented. When a set of modules change and must be upgraded atomically, the changes to all parts of the module code-base for each module may be bundled together, including client, server and storage code. The bundle may then be installed on the server (e.g., the service platform).

In order to present a manageable programming interface for a developer, example embodiments may employ a declarative language to describe the messages which are transmitted between the client (e.g., the mobile terminal 10) and the server (e.g., the service platform 50), as well as the data structures that are stored in the server's database (e.g., a portion of memory device 76′). In some embodiments, the message manager 92 may be configured to manage messaging associated with upgrading of the VM 80 that is managed by the versioning manager 90. As such, when the developer describes a new version of the software, the message manager 92 may be configured to automatically add the new and modified messages to the server's library of messages, track which client uses which messages, and database storage and retrieval messages to the new data model as appropriate.

Since, as indicated above, embodiments of the present invention may be enabled to operate in high latency, low bandwidth or otherwise unreliable communication environments, messaging may be conducted using a relatively low cost communication transport mechanism. In some embodiments, SMS may form the transport for providing messages between the service platform 50 and the mobile terminal 10. The SMS transport mechanism may therefore be employed by users having devices that lack capabilities for employing more sophisticated communication transport modes or for users that do not desire to incur the cost associated with more sophisticated communication transport modes or devices that implement such modes.

In an example embodiment, a typical protocol stack may be employed by the VM 80 and the message manager 92 for data transmission, with typical “transport layer” functions being implemented. Thus, for example, a binary protocol with messages packed in SMS messages by compressing them into an efficient binary form using a typical compression algorithm such as one of the LZ compression algorithms or Huffman codes may be employed. These types of compressed messages may then be encoded (e.g., in 7-bit form) and queued in an outgoing message queue. Messages from the queue may be packed into SMS messages (and fragmented if they are more than the length of a SMS message, typically 150 or 160 7-bit characters). The messages may then be reassembled on the receiving side (e.g., by the VM 80 of the message manager 92), including reordering and retransmitting as necessary.

In some embodiments, the message manager 92 may be configured to mark messages as reliable or unreliable. Reliable messages may be made reliable by positive or negative acknowledgment, or by forward error-correction or universal coding. In some cases, implementation may take the form of a transport control protocol (TCP)-like reliability mechanism that relies on positive acknowledgement. In some cases, in order to avoid incurring unnecessary cost for the user, control messages (such as acknowledgments) may be bundled with user initiated data messages (e.g., chat messages in a chat application). A typical implementation may include multiple priority queues (e.g., a high priority queue, which sends messages immediately, a low priority queue, which bundles messages with high priority messages, and a timed queue which will attempt to bundle messages with high priority messages), but may explicitly send a message if no high priority message is sent before a timeout period defined for the corresponding message expires, or if the queue fills.

In some cases, application semantics may change for messages, even when the protocol does not. In such case, the versioning manager 90 may also track information defining with which version of the server software a mobile client needs to communicate. For some bug fixes and enhancements, the client and/or server semantics may change and the old semantics should not be preserved, because the old semantics are incorrect or less sophisticated. In cases in which a change does not introduce incompatibilities, the change should be marked as such, and upgrades would therefore not need to occur simultaneously between clients and the server. Thus, isolated semantic changes may be marked as such, to minimize upgrade overhead. In the event that changes a developer makes introduce a fundamental incompatibility between software versions, the versioning manager 92 may force the client to upgrade its software before proceeding.

In some embodiments, the message manager 92 may be configured to declare the messages that are to be sent between the service platform 50 and various clients. Message structure may be defined using an extensible markup language (XML) description. The compiler described above with respect to the VM 80 may then distil the description into code for the client and server to marshal and demarshal data as appropriate. Corresponding function calls may also be provided for the sender and callback for the receiver, which may facilitate sending and receiving messages.

In an example embodiment, persistent data structures may also be declared. As data structures change, the versioning manager 90 may be configured to generate storage adapters that may be configured to either migrate data from an old format to a new one, and then provide backwards compatibility for older clients using an adapter, or simply provide a batch mechanism to upgrade the data once the client upgrades in cases where an online adapter is impractical, unnecessary or impossible. A batch upgrade may be sufficient if the data model upgrade does not affect data that are shared by multiple users.

In a typical implementation, storage may be migrated to a new format by creating a new table in a relational database using the difference in the old data-structure and the new to model the change necessary in the underlying relational database. The same differences may then be used to generate a storage adapter which allows the code that uses the old data structure to access the data in the new table.

In examples in which a storage adapter can not be automatically generated (such as when the new data structure has a new required field without a suitable default value), or when the data from a persistent data structure are not shared between users, the old data structure and storage may be used by the old code, and the new data structure may be used by the new code. In this case, the old clients may not be able to see data used by the new clients. If this situation is unacceptable, then the developer may specify that the upgrade is mandatory before the users will be able to use the system again.

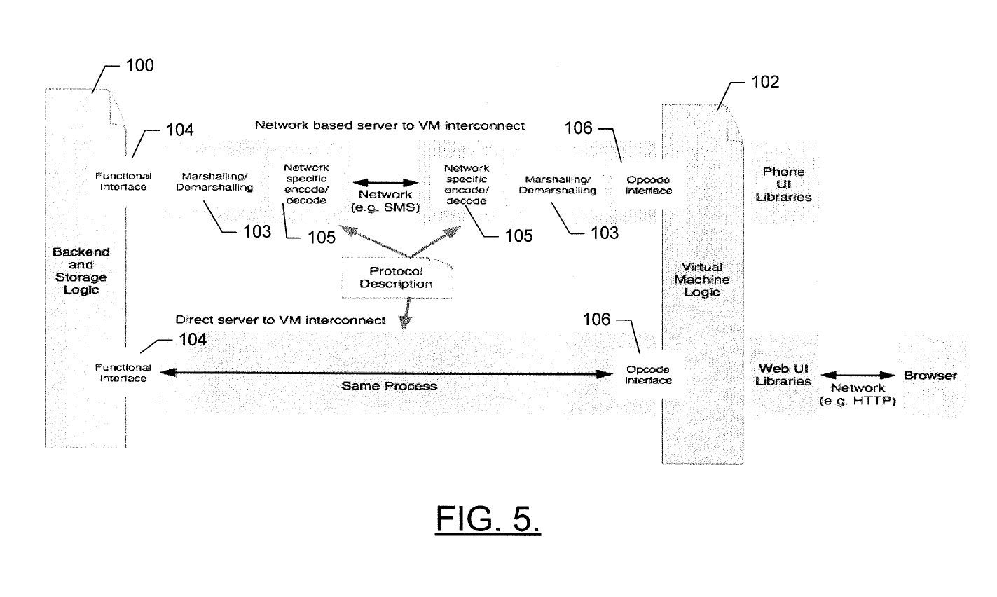

FIG. 5 illustrates an example of potential systems that may be constructed by specifying backend processing and storage logic 100 at one device (e.g., the service platform 50 acting as a server) and virtual machine logic 102 (e.g., VM 80) at a client device and by specifying the protocol for communication between the backend processing and storage logic 100 and the virtual machine logic 102. As shown in FIG. 5, in one embodiment network based (e.g., SMS) communication may be used for interconnection, while in an alternative embodiment, the backend processing and storage logic 100 may be directly connected (e.g., via being collocated) to the virtual machine logic 102 (e.g., VM 80).

In an example implementation of the first embodiment described above (e.g., using network based communication), the virtual machine logic 102 may enable running of web-like applications and services via low bandwidth, low reliability and/or high latency communication channels. In this regard, the backend processing and storage logic 100 may include a functional interface 104 enabling marshalling and demarshalling functions (as indicated by block 103) to be implemented along with network specific coding and encoding (as indicated by block 105) to use network communication (e.g., via SMS). The virtual machine logic 102 may include an opcode interface 106 for enabling marshalling and demarshalling functions to be implemented along with network specific coding and encoding to use network communication (e.g., via SMS). The virtual machine logic 102 may therefore be enabled to access phone user interface libraries to carry out high level operations.

In the second embodiment (e.g., via direct connection), the virtual machine logic 102 may be running at the server to enable the running of the same interface on multiple platforms or client devices. In this example, the functional interface and the opcode interface may be directly interconnected. As such, it may be possible to abstract user specific program code to move user specific code to other locations. Accordingly, for example, using the example embodiments shown in FIG. 5, the same applications or interfaces may be presented to individuals with smart phones and mobile terminals with lesser capabilities or perhaps out of range of high quality service.

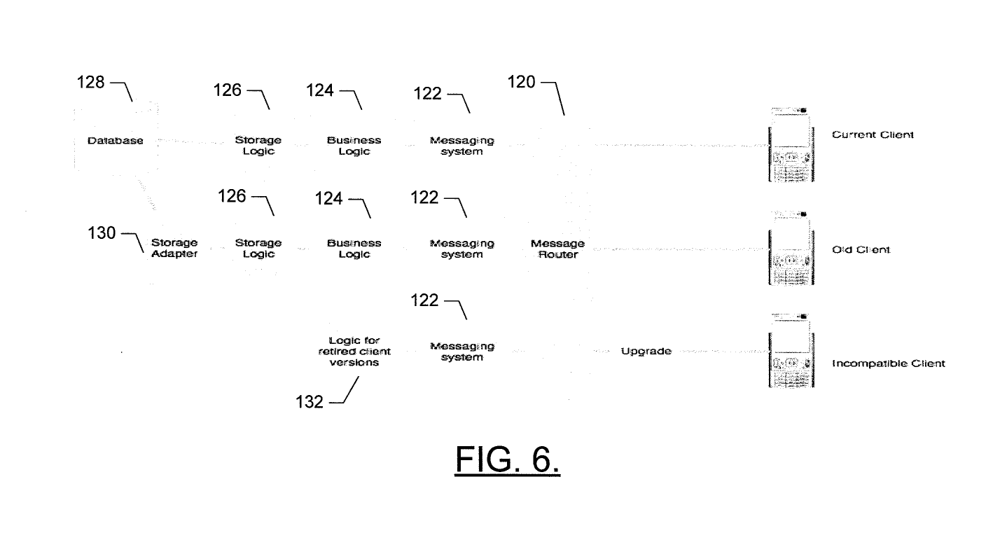

FIG. 6 illustrates an example in which operation of an example embodiment is shown for each of three different scenarios including a client with current software, a client that includes old software that has not yet been upgraded and a client that is incompatible based on its current software. In this regard, for a client including current software, a message router 120 may route messages to the messaging system 122 (which may include message manager 92). The currently employed business logic 124 and storage logic 126 may then be implemented based on the database 128 indicating that the business logic 124 and storage logic 126 are current. Meanwhile, for a client device employing older code due to an inability to upgrade, the message router 120 may again route messages to the messaging system 122. However, in this instance, the database 128 may indicate that the format of the data structures has changed. Thus, a storage adapter 130 may be implemented in this case in order to either upgrade the client or migrate data from the old format to the new format. For an incompatible client, an upgrade may initially be required and then ultimately, logic for retired client versions 132 may be consulted in order to attempt to implement compatible functionality while partitioning incompatible portions off.

Embodiments of the present invention may be used in connection with a plurality of different scenarios, some of which are described herein by way of example. In this regard, some embodiments may be used in connection with a mobile marketplace application. In such an application, sellers may be enabled to offer goods and services for sale, and buyers can search for items in which they are interested. The VM 80 may provide the interfaces that are to be provided to the user based on locally stored templates previously provided by the service platform 50. Specific information corresponding to items to be presented in the marketplace may be updated periodically, also by messages from the service platform. In one example, a seller may offer a microwave oven or other item for sale. The seller may post the microwave for sale via the marketplace service hosted by the service platform 50. To do this, the seller may browse a taxonomy of products to find microwave ovens, and selects the corresponding category. Parameters descriptive of the microwave may then be entered (e.g., wattage, size, brand, model, age and price of the product). In some cases, the seller may use service specific virtual money or a credit card to pay for advertising the product. Interested potential buyers may contact the seller through the service via SMS chat. The buyer may look at the microwave and agree to buy it. When the buyer's service specific virtual money or other payment has arrived in the seller's inbox, the seller may give the buyer the microwave, and then goes to a service specific point of sale to cash in some of service specific virtual money.

In an alternative example, a buyer may be looking for a microwave oven to purchase. The buyer may search for microwave ovens available for sale nearby. A list of ovens for sale nearby may return no attractive results. The buyer may then subscribe to get updates as new ovens come up for sale. Alternatively, the buyer may broaden the geographic area over which the buyer is willing to travel to buy a microwave oven. Over the next few days, the buyer may be notified of other posts related to microwave ovens. Finally, when someone posts the oven model the buyer is interested in at a reasonable price, the buyer may contact the seller securely through the application by exchanging messages that are routed through the server. The buyer and seller may then arrange to meet and check out the microwave oven. The buyer and seller may agree on a final price and payment may be made as indicated above or by some other mechanism.

In still another example, a cloth shop owner may post several sale items in the online marketplace. The shop owner may pay for the advertising service with mobile minutes. The seller may also post a phone number and address and a coupon code for buyers. Several people may then come to the shop with the coupon code, and purchase items in addition to the sale items.

In another use case, the user may start using a service associated with software that is pre-installed on the client device of the user. The user may then choose an available service from a directory. The user may then continue to use the client device with other services, applications, etc. Meanwhile, the execution environment may reassemble client code from delayed, fragmented, dropped and reordered messages. The execution environment may then install the latest version of the mobile-terminal code and notify the user that the user may now use the service.

In another example, a developer may upgrade a message. Initially, the developer may install a new messaging protocol into the server. The server may inform each client about the new messaging protocol by sending messages to each client, or by marking messages using the old protocol as depricated. For clients that receive the message, they initiate the download of the client software modules which are affected by the protocol change, while the user continues to use the service, if applicable. Once the download has completed, the client requests to the user to restart itself if necessary (after saving their temporary state where applicable). The client then begins using the new protocol. For clients that continue to use the old protocol, messages from the server are marked as depricated until the client upgrades.

In a case where the developer upgrades messaging semantics and server-side storage, the developer may initially install new code on the server, indicating which client-side modules need to be upgraded, if any. The server may upgrade the storage immediately, and then use an automatically generated storage adapter to preserve backward compatibility with old server-side storage protocols. In cases involving major storage upgrades, or in cases where the data in the database are not shared between clients, the server may continue to use the old storage protocols until the client upgrades, at which time the data corresponding to that client is migrated to the new storage protocol. The client may be upgraded as above. For clients using the new code (as indicated by a system-managed version indicator for the client-side module), the server may respond to messages using the upgraded semantics and storage protocol. In some cases, the storage or semantics will be fundamentally incompatible between versions. In these cases, clients using the old protocol may be informed that they will no longer function until they are upgraded.

In another example, a developer may fix a client-side bug. In this example, the developer may install a bug fix or upgrade that only effects client side behavior (such as a new text completion algorithm, for example), and thus is marked as isolated. The client may be informed, either by an explicit message or a flag in other messages that it needs to upgrade. The client may request the upgrade, which the server provides. The client may then upgrade and restart.

In still another example, a developer may fix a server-side bug. In this example, the developer may install a bug fix or upgrade that only effects server side behavior (such as a new localization algorithm), and thus is marked as isolated. All clients using the current version of effected modules may immediately benefit from the upgrade. Clients using previous versions of the effected modules may not see any change. Thus, no client change may be propagated.

In yet another example, a developer may make an incompatibility introducing change. In such an example, the developer may install a bug fix that introduces a fundamental incompatibility between versions, such as an upgrade to storage which changes extensive and complex interdependencies between data structures. The data model may be upgraded. Clients may be informed that they are required to upgrade. Clients that do not upgrade may be informed that the service will remain unavailable until they upgrade. Upgrades may then proceed as described above.

Accordingly, as described above, the VM 80 may be a virtual machine that is configured to handle and execute high level opcodes. However, the VM 80 is also dynamically upgradeable by the service platform 50, which also tracks versioning of the VM 80 and other clients over time to facilitate communication with each client based on the versions of the upgrades or software that are currently active at each respective client device. The message manager 92 of some embodiments also manages the messages that are exchanged between the service platform 50 and the clients to ensure communication is exchanged in accordance with the upgrade status of each respective client. Although the message manager 92 of an exemplary embodiment is embodied at the service platform 50, in some cases an instance may also be embodied at each respective client.

Thus, embodiments of the present invention may provide a service oriented software architecture that enables users without access to reliable, reasonably low-latency, high-bandwidth connections to enjoy many of the benefits of typical web services. In this regard, for example, embodiments of the present invention may provide developers with an environment in which to quickly develop services with the management benefits of web services, but with a potentially larger reach.

More specifically, using a “high-level virtual machine” allows the environment to very efficiently encode software for transmission to client devices without sacrificing flexibility. While java virtual machines are flexible, they may be considered by some to have inefficient encoding and therefore do not provide for over-the air upgrades for low bandwidth links. Moreover, the ability to perform partial upgrades is also provided by some embodiments. The user interface description of some examples may be used to deploy web-based and virtual machine based services simultaneously. The control logic and user interface description that executes in the virtual machine may execute on a web server as well, making appropriate calls to web based display and service libraries, rather than rewriting code. Accordingly, productivity may be increased and maintenance costs may be reduced.

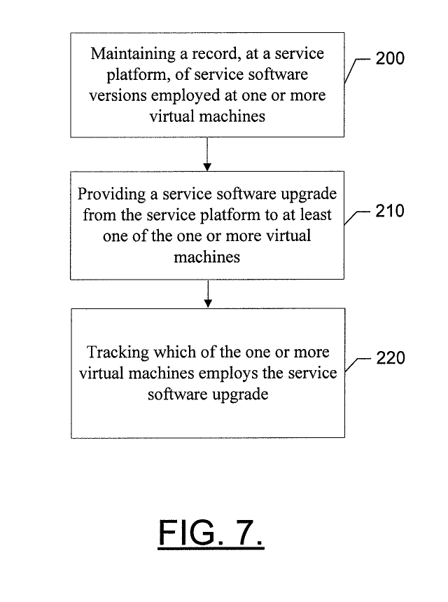

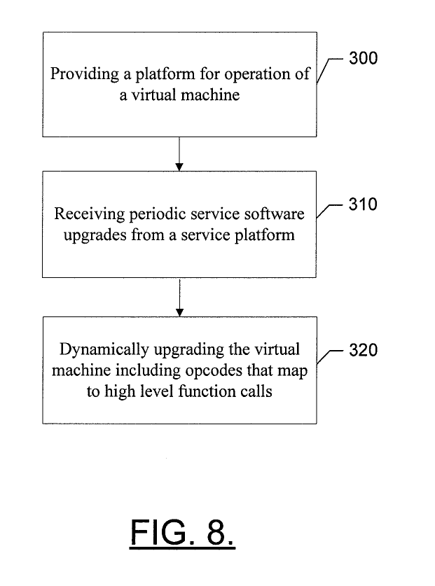

FIGS. 7 and 8 are each flowcharts of a method and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts block(s). These computer program instructions may also be stored in a computer-readable memory that may direct a computer or other programmable apparatus to function in a particular manner, such that the instructions stored in the computer-readable memory produce an article of manufacture including means which implement the functions specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts block(s).

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, a method according to one embodiment of the invention, as shown in FIG. 7, may include maintaining a record, at a service platform, of service software versions employed at one or more virtual machines at operation 200. The method may further include providing a service software upgrade from the service platform to at least one of the one or more virtual machines at operation 210 and tracking which of the one or more virtual machines employs the service software upgrade at operation 220.

In some embodiments, certain ones of the operations above may be modified or further amplified as described below. It should be appreciated that each of the modifications or amplifications below may be included with the operations above either alone or in combination with any others among the features described herein. In this regard, for example, maintaining the record may include storing a record of messages exchanged between the service platform and virtual machines, and/or tracking which of the one or more virtual machines employs the service software upgrade may include tracking which messages are used by respective ones of the one or more virtual machines. In some embodiments, providing the service software upgrade may include transmitting the service software upgrade to a remote virtual machine via wireless communication (e.g., SMS). In an example embodiment, providing the service software upgrade may include providing an indication of isolated semantic changes to reduce upgrade overhead and/or providing an indication of one or more modules dependent on a module being upgraded by the service software upgrade. In an example embodiment, providing the service software upgrade may include transmitting the service software upgrade based on a priority assigned to the service software upgrade. In some embodiments, the method may include providing different data to a remote virtual machine than data provided to other ones of the one or more virtual machines based on a software version of the remote virtual machine.

In an example embodiment, an apparatus for performing the method of FIG. 7 above may comprise a processor (e.g., the processor 70′) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the processor 70′, the versioning manager 90, the message manager 92, and/or a device or circuit for executing instructions or executing an algorithm for processing information as described above.

In an alternative embodiment from the perspective of the virtual machine, a method for providing a high level mobile virtual machine according to one embodiment of the present invention, as shown in FIG. 8, may include providing a platform for operation of a virtual machine at operation 300 and receiving periodic service software upgrades from a service platform (e.g., dynamically via wireless communication (e.g., SMS)) at operation 310. The service platform may track versioning of the service software upgrades by ensuring that messaging, semantics and data storage operate simultaneously. The method may further include dynamically upgrading the virtual machine including opcodes that map to high level function calls at operation 320. The high level function calls may include library function calls including at least one of sending a short message service (SMS) message, marshalling or unmarshalling of messages, initiation of a phone call, loading frames onto a display screen from a template, or storing a record of data persistently.

In an example embodiment, an apparatus for performing the method of FIG. 8 above may comprise a processor (e.g., the processor 70) configured to perform some or each of the operations (300-320) described above. The processor may, for example, be configured to perform the operations (300-320) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-320 may comprise, for example, the processor 70, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
maintaining a record, at a service platform, of service software versions employed at one or more virtual machines;
providing a service software upgrade from the service platform to at least one of the one or more virtual machines; and
tracking which of the one or more virtual machines employs the service software upgrade.

2. The apparatus of claim 1, wherein the at least one memory and the computer program code are further configured to, with the at least one processor, cause the apparatus to maintain the record by storing a record of messages exchanged between the service platform and virtual machines.

3. The apparatus of claim 2, wherein the at least one memory and the computer program code are further configured to, with the at least one processor, cause the apparatus to track which of the one or more virtual machines employs the service software upgrade by tracking which messages are used by respective ones of the one or more virtual machines.

4. The apparatus of claim 1, wherein the at least one memory and the computer program code are further configured to, with the at least one processor, cause the apparatus to provide the service software upgrade by transmitting the service software upgrade to a remote virtual machine via wireless communication.

5. The apparatus of claim 4, wherein the at least one memory and the computer program code are further configured to, with the at least one processor, cause the apparatus to transmit the service software upgrade via a short message service (SMS) message.

6. The apparatus of claim 1, wherein the at least one memory and the computer program code are further configured to, with the at least one processor, cause the apparatus to transmit the service software upgrade based on a priority assigned to the service software upgrade.

7. The apparatus of claim 1, wherein the at least one memory and the computer program code are further configured to, with the at least one processor, cause the apparatus to provide the service software upgrade including providing an indication of isolated semantic changes to reduce upgrade overhead.

8. The apparatus of claim 1, wherein the at least one memory and the computer program code are further configured to, with the at least one processor, cause the apparatus to provide the service software upgrade including providing an indication of one or more modules dependent on a module being upgraded by the service software upgrade.

9. The apparatus of claim 1, wherein the at least one memory and the computer program code are further configured to, with the at least one processor, cause the apparatus to provide different data to a remote virtual machine than data provided to other ones of the one or more virtual machines based on a software version of the remote virtual machine.

10. A method comprising:
maintaining a record, at a service platform, of service software versions employed at one or more virtual machines;
providing a service software upgrade from the service platform to at least one of the one or more virtual machines; and
tracking which of the one or more virtual machines employs the service software upgrade.

11. The method of claim 10, wherein maintaining the record comprises storing a record of messages exchanged between the service platform and virtual machines, and wherein tracking which of the one or more virtual machines employs the service software upgrade comprises tracking which messages are used by respective ones of the one or more virtual machines.

12. The method of claim 10, wherein providing the service software upgrade comprises transmitting the service software upgrade to a remote virtual machine via wireless communication.

13. The method of claim 12, wherein transmitting the service software upgrade comprises transmitting the service software upgrade via a short message service (SMS) message.

14. The method of claim 10, wherein providing the service software upgrade comprises providing an indication of isolated semantic changes to reduce upgrade overhead.

15. The method of claim 10, wherein providing the service software upgrade comprises providing an indication of one or more modules dependent on a module being upgraded by the service software upgrade.

16. A computer program product comprising at least one computer-readable storage medium having computer-executable program code instructions stored therein, the computer-executable program code instructions comprising:
program code instructions for maintaining a record, at a service platform, of service software versions employed at one or more virtual machines;
program code instructions for providing a service software upgrade from the service platform to at least one of the one or more virtual machines; and
program code instructions for tracking which of the one or more virtual machines employs the service software upgrade.

17. The computer program product of claim 16, wherein program code instructions for maintaining the record include instructions for storing a record of messages exchanged between the service platform and virtual machines, and wherein program code instructions for tracking which of the one or more virtual machines employs the service software upgrade include instructions for tracking which messages are used by respective ones of the one or more virtual machines.

18. The computer program product of claim 16, wherein program code instructions for providing the service software upgrade include instructions for transmitting the service software upgrade to a remote virtual machine via wireless communication.

19. The computer program product of claim 15, wherein program code instructions for providing the service software upgrade include instructions for providing an indication of isolated semantic changes to reduce upgrade overhead.

20. The computer program product of claim 15, wherein program code instructions for providing the service software upgrade include instructions for providing an indication of one or more modules dependent on a module being upgraded by the service software upgrade.

21. An apparatus comprising at least one processor and at least one memory including computer program code, the at least one memory and the computer program code configured to, with the at least one processor, cause the apparatus at least to perform:
providing a platform for operation of a virtual machine;
receiving periodic service software upgrades from a service platform; and
dynamically upgrading the virtual machine including opcodes that map to high level function calls.

22. The apparatus of claim 21, wherein the at least one memory and the computer program code are further configured to, with the at least one processor, cause the apparatus to receive the periodic service software upgrades via wireless communication.

23. The apparatus of claim 21, wherein the at least one memory and the computer program code are further configured to, with the at least one processor, cause the apparatus to dynamically upgrade the virtual machine with opcodes that map to library function calls including at least one of sending a short message service (SMS) message, marshalling or unmarshalling of messages, initiation of a phone call, loading frames onto a display screen from a template, or storing a record of data persistently.

24. A method comprising:
providing a platform for operation of a virtual machine;
receiving periodic service software upgrades from a service platform; and
dynamically upgrading the virtual machine including opcodes that map to high level function calls.

25. The method of claim 24, wherein receiving periodic service software upgrades comprises receiving the periodic service software upgrades via wireless communication.

26. The method of claim 24, wherein dynamically upgrading the virtual machine comprises upgrading the virtual machine with opcodes that map to library function calls including at least one of sending a short message service (SMS) message, marshalling or unmarshalling of messages, initiation of a phone call, loading frames onto a display screen from a template, or storing a record of data persistently.

27. A computer program product comprising at least one computer-readable storage medium having computer-executable program code instructions stored therein, the computer-executable program code instructions comprising:
program code instructions for providing a platform for operation of a virtual machine;
program code instructions for receiving periodic service software upgrades from a service platform; and
program code instructions for dynamically upgrading the virtual machine including opcodes that map to high level function calls.

28. The computer program product of claim 27, wherein program code instructions for receiving periodic service software upgrades include instructions for receiving the periodic service software upgrades via wireless communication.

29. The computer program product of claim 27, wherein program code instructions for dynamically upgrading the virtual machine include instructions for upgrading the virtual machine with opcodes that map to library function calls including at least one of sending a short message service (SMS) message, marshalling or unmarshalling of messages, initiation of a phone call, loading frames onto a display screen from a template, or storing a record of data persistently.
